(19) United States
(12) Patent Application Publication
(10) Pub. No.: US 2016/0284122 A1
(43) Pub. Date: Sep. 29, 2016

(54) 3D MODEL RECOGNITION APPARATUS AND METHOD

(71) Applicant: Intel Corporation, Santa Clara, CA (US)

(72) Inventors: Igor Tatourian, Fountain Hills, AZ (US); Sudip S. Chahal, Gold River, CA (US); Norman Yee, Folsom, CA (US); Greeshma Yellareddy, San Francisco, CA (US)

(21) Appl. No.: 14/670,000

(22) Filed: Mar. 26, 2015

(51) Int. Cl. G06T 17/20; G05B 19/4099; G06N 99/00

(52) U.S. Cl. CPC G06T 17/20; G06N 99/005; G05B 19/4099; G05B 2219/49023

(57) ABSTRACT

In embodiments, apparatuses, methods and storage media (transitory and non-transitory) are described that receive a first 3D model of a 3D object, and determine a second 3D model to replace the first 3D model, wherein the second 3D model is a fuller representation of the 3D object than the first 3D model. In embodiments, the second 3D model may be manipulated, metadata corresponding to a material property of the 3D object may be provided, 3D models of component parts of the 3D object may be provided, or the second 3D model may be used to construct an object with a 3D printer. Other embodiments may be described and/or claimed.

### TECHNICAL FIELD

The present disclosure relates to the field of data processing, in particular to three dimensional (3D) object recognition and 3D model manipulation apparatuses and methods.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Existing techniques for extracting representations of 3D objects from two dimensional (2D) images typically require additional user input and may have limitations in their ability to extract a complete representation of the 3D object.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 is a block diagram of a network environment including a computing device having 3D object recognition and manipulation technology of the present disclosure, in accordance with various embodiments.

FIG. 2 is a flow diagram of an example process of receiving a first 3D model and determining a second 3D model that may be implemented on various computing devices described herein, in accordance with various embodiments.

FIG. 3 is a flow diagram of an example process of capturing a 2D image, extracting a first 3D model, and receiving a second, fuller 3D model, that may be implemented on various computing devices described herein, in accordance with various embodiments.

FIG. 4 illustrates an example 2D object outline, in accordance with various embodiments.

FIG. 5 illustrates an example computing environment suitable for practicing various aspects of the disclosure, in accordance with various embodiments.

FIG. 6 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. The term “module” may refer to software, firmware and/or circuitry that is/are configured to perform or cause the performance of one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may collectively or individually be embodied as circuitry that forms a part of a computing device. As used herein, the term “processor” may be a processor core.

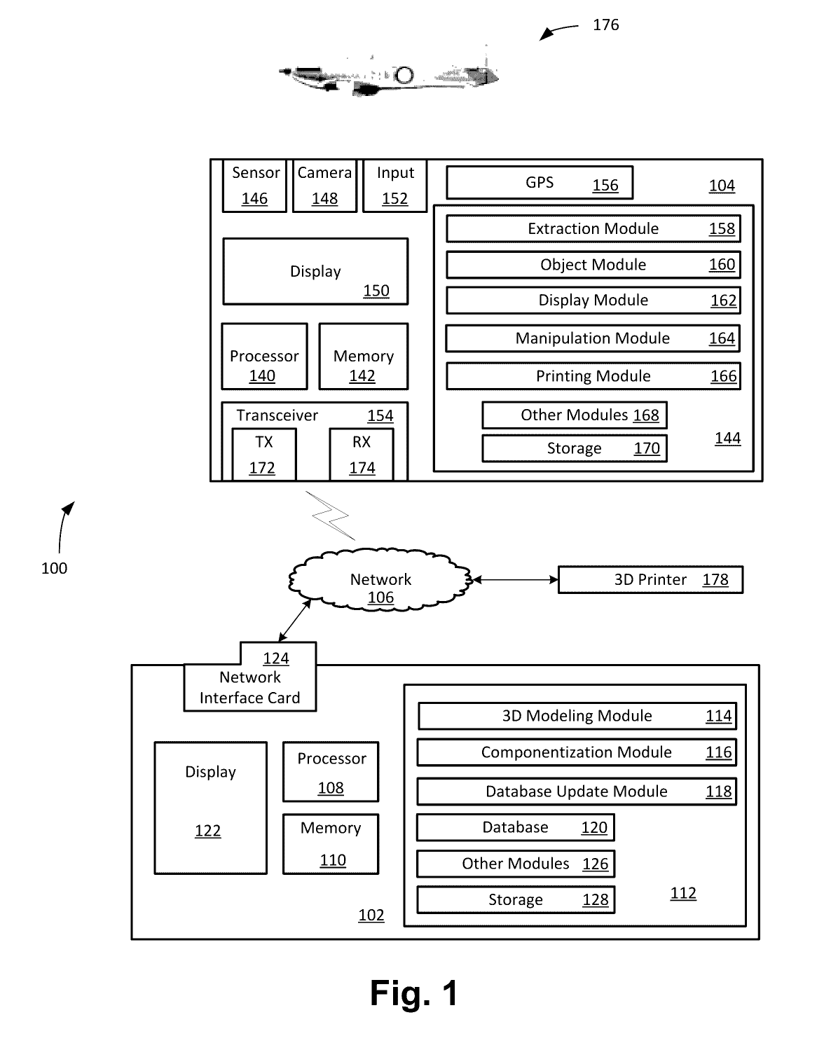

Referring now to FIG. 1, a network environment 100, including a computing device 102 and a computing device 104 having 3D object recognition and manipulation technology of the present disclosure, in accordance with various embodiments, is illustrated. The computing device 102 may be included in a cloud computing environment in various embodiments. In embodiments, the computing device 104 may be in wireless data communication with the computing device 102 over a network 106. As shown, computing device 102 may include a number of components 108-128, including a processor 108, a system memory 110, an execution environment 112, a 3D modeling module 114, a componentization module 116, a database update module 118, a database 120, a display 122, and a network interface card 124 that may be coupled together and configured to cooperate with each other to receive a first 3D model from the computing device 104 and determine a second 3D model that is a fuller representation of a 3D object than the first 3D model. In embodiments, the execution environment 112 may also include other modules 126 and storage 128. In embodiments, one or more of the modules in the execution environment 112 may be within another module. The execution environment 112 may also include an operating system operated by the processor 108.

As shown, computing device 104 may include a number of components 140-174, including a processor 140, a system memory 142, an execution environment 144, a sensor 146, such as an ultrasonic sensor for example, a camera 148, a display 150, an input device 152, a transceiver 154, and a location module such as a geographic positioning system (GPS) 156 that may be coupled together and configured to cooperate with each other to take a two dimensional (2D) image of a 3D object, extract a first 3D model representation of the 3D object from the 2D image, send the first 3D model to the computing device 102, receive a fuller second 3D model of the 3D object from the computing device 102, and perform additional actions with the second 3D model, in accordance with various embodiments. The execution environment 144 may include an extraction module 158, an object module 160, a display module 162, a manipulation module 164, and a printing module 166. In embodiments, the execution module 144 may also include other modules 168, and storage 168. One or more of the modules in the execution environment 144 may be within another module in various embodiments. The execution environment 144 may also include an operating system operated by the processor 140. In embodiments, the transceiver 154 may include transmitting circuitry 172 and receiving circuitry 174. The computing device 104 may be a device such as a smartphone in various embodiments. The camera 148 may be used to take a picture and generate a 2D image of a 3D object 176 in various embodiments.

In embodiments, the 3D modeling module 114 may be operated by the processor 108 to generate a 3D object recognition algorithm based at least in part on a machine learning process and information in the database 120. In embodiments, the 3D object recognition algorithm may match a 3D model of a 3D object to a partial, or less full, 3D model of the 3D object, or to a 2D image of the 3D object. The 3D modeling module 114 may also be operated by the processor 108 to update the 3D object recognition algorithm in response to additional information being stored in the database 120. In embodiments, the initial information in the database 120 may include images taken with a camera or video capture device, sensor data, 2D images, 3D images, 2D models, 3D models, data structures, material properties of an object represented by an image or model, or metadata associated with the image or model that may include one or more labels such as a name of the object represented, for example. The initial information may also include similar information (e.g., images, models, sensor data, data structures, metadata, etc.) relating to one or more component parts of one or more 3D objects.

In embodiments, the database update module 118 may be operated by the processor 108 to populate the database 120 based at least in part on information received using a crowdsourcing model or based at least in part on information received from professional sources. In embodiments, information may be received from one or more autonomous or remotely operated sensing devices such as an autonomous or remotely operated robot used to take images in a mineshaft or an insect-sized device used to image or otherwise sense an interior of a structure. In embodiments, the 3D modeling module 114 may be operated by the processor 108 to generate one or more mathematical models that represent one or more 3D objects. In embodiments, the mathematical models may be based at least in part on representing the corresponding objects using topological geometry. In embodiments, the 3D object recognition algorithm may be based at least in part on the generated mathematical models.

In embodiments a user may take a picture of a 3D object such as an airplane with a smartphone.

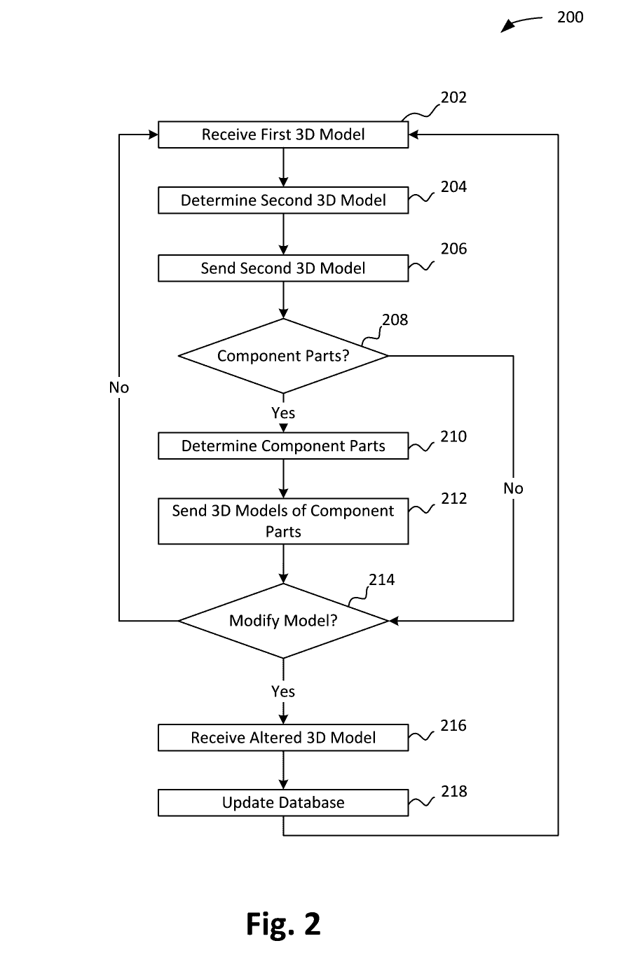

FIG. 2 depicts an example process 200 for receiving a first 3D model and determining a second 3D model based at least in part on the first 3D model that may be implemented by the computing device 102 in accordance with various embodiments. In various embodiments, the process 200 may be performed by the 3D modeling module 114, the componentization module 116, the database update module 118, and the database 120. In other embodiments, the process 200 may be performed with more or less modules and/or with some operations in different order.

As shown, for embodiments, the process 200 may start at a block 202 where a first 3D model of a 3D object may be received. The first 3D model may be received at the computing device 102 from the computing device 104, for example. The first 3D model may be a partial representation of the 3D object in various embodiments. The first 3D model may be received as a first data structure. At a block 204, a second 3D model may be determined based at least in part on the first 3D model. In embodiments, the 3D modeling module 114 may be operated by the processor 108 to determine the second 3D model, which may be a fuller representation of the 3D object than the first 3D model and may be used by the 3D modeling module 114 to replace the first 3D model. The second 3D model may close gaps present in the first 3D model or may complete incomplete portions of a partial first 3D model in various embodiments. The 3D modeling module 114 may determine the second 3D model based at least in part on rotating and scaling at least one of the first 3D model or the second 3D model. In embodiments, the 3D modeling module 114 may determine the second 3D model based at least in part on a machine learning algorithm. The 3D modeling module 114 may determine the second 3D model based at least in part on the 3D object recognition algorithm in various embodiments. In embodiments, the 3D modeling module 114 may receive a 2D image of a 3D object rather than a first 3D model of the 3D object and may determine the second 3D model based at least in part on the received 2D image.

At a block 206, the second 3D model may be sent to the computing device from which the first 3D model was received. In embodiments, the second 3D model may be sent as a second data structure. The computing device 102 may send the second data structure to the computing device 104, for example.

At a decision block 208, it may be determined whether a request to provide models of component parts corresponding to the 3D object has been received. The request may be received at the computing device 102 from the computing device 104, for example. If, at the decision block 208, it is determined that a request to provide models of component parts has been received, the process 200 may proceed to a block 210 where component parts corresponding to the second 3D model may be determined. At a block 212, one or more 3D models of component parts corresponding to the second 3D model may be sent to the computing device from which the first 3D model was received. The 3D models of the component parts may be sent as one or more data structures in various embodiments. In embodiments, the componentization module 116 may be operated by the processor 108 to determine component parts at the block 210 and send the 3D models of the component parts at the block 212.

At a decision block 214, it may be determined whether a request has been received to modify the second 3D model. The request may be received at the computing device 102 from the computing device 104, for example. The process 200 may also proceed to the decision block 214 if, at the decision block 208, it is determined that a request to determine component parts has not been received. If, at the decision block 214, it is determined that a request to modify the second 3D model has been received, an altered 3D model may be received at a block 216. In embodiments, a virtual skeleton model of the 3D object may be determined based at least in part on the second 3D model and sent to the other computing device before receiving the altered 3D model, which may be an altered virtual skeleton model in embodiments. In embodiments, the 3D modeling module 114 may be operated by the processor 108 to determine the virtual skeleton model and send the virtual skeleton model to a computing device such as the computing device 104.

At a block 218, a database, such as the database 120, for example may be updated based at least in part on the altered 3D model. In embodiments, the database update module 118 may be operated by the processor 108 to update the database 120. If, at the decision block 214, it is determined that a request to modify the second 3D model has not been received, the process 200 may return to the block 202 where the computing device may receive another 3D model corresponding to another 3D object. In embodiments, the process 200 may also return to the block 202 after updating the database at the block 218.

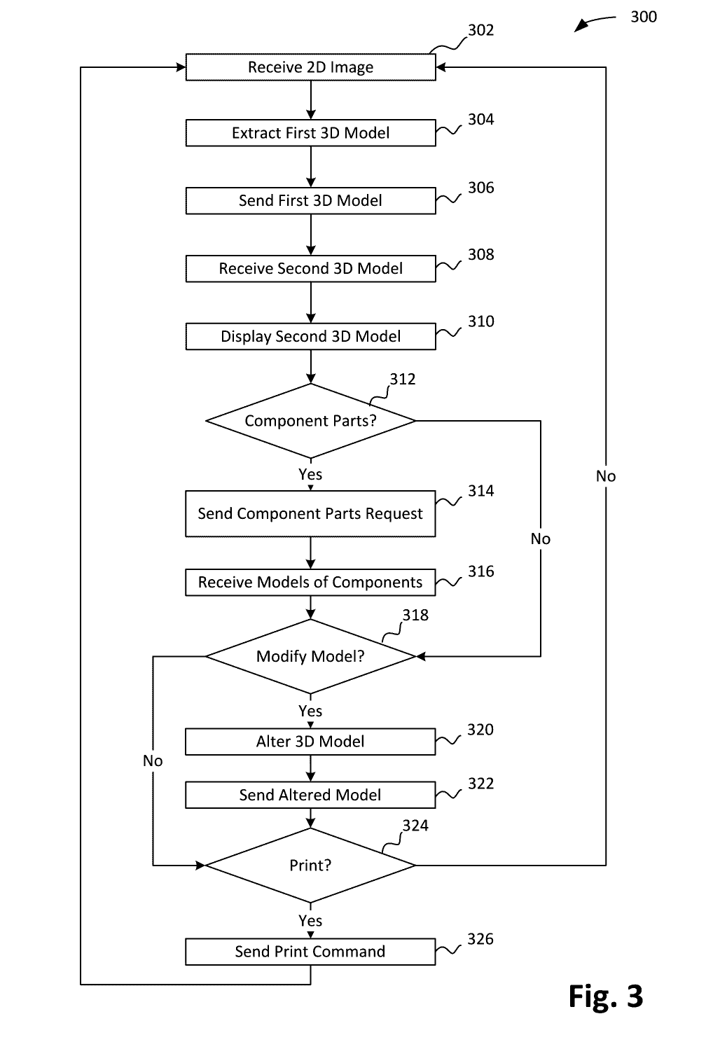

FIG. 3 is a flow diagram of an example process 300 for capturing a 2D image of a 3D object, extracting a first 3D model from the 2D image, and performing additional actions on a second 3D model based at least in part on the first 3D model that may be implemented on various computing devices described herein, in accordance with various embodiments. The process 300 may start at a block 302 where a 2D image may be received. In embodiments, the extraction module 158 may be operated by the processor 140 to receive the 2D image, which may be based at least in part on a picture of a 3D object, such as the object 176, taken by the camera 148. In embodiments, more than one 2D image may be received at the block 302. The extraction module 158 may be operated by the processor 140 to prompt a user to take additional pictures in some embodiments. Additional data, such as sensor data from the sensor 146 (e.g., ultrasonic sensor data) may be received by the extraction module 158 at the block 302. In embodiments, the extraction module 158 may determine material properties such as density based at least in part on the sensor data.

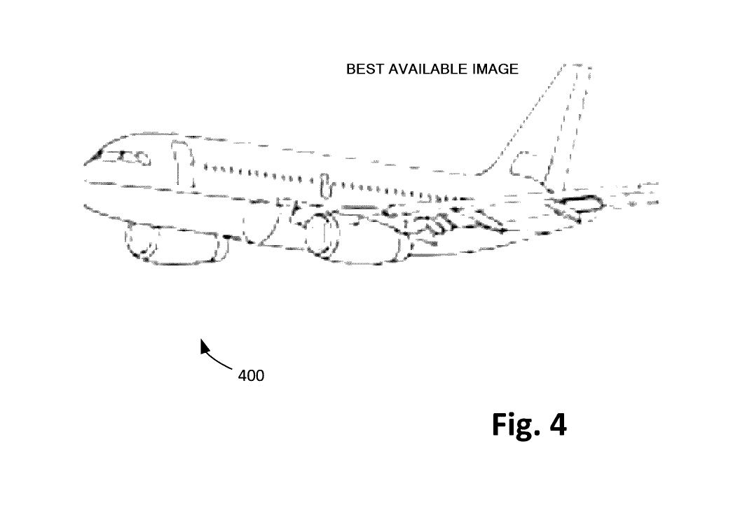

At a block 304, a first 3D model may be extracted based at least in part on the 2D image. In embodiments, an outline of an object in the 2D image, such as the outline shown in FIG. 4 for example, may be determined before extracting the first 3D model. In embodiments, the extraction module 158 may be operated by the processor 140 to receive the 2D image and extract the first 3D model. The extraction module 158 may be operated by the processor 140 to extract the first 3D model based at least in part on more than one 2D image in some embodiments, and may extract the first 3D model based at least in part on a single 2D image in embodiments. The first 3D model may include metadata based at least in part on sensor data received at the block 302 or a label added by a user at the input device 152 in various embodiments. The metadata may include properties of materials of the 3D object, such as information corresponding to a material density that may be sensed by the sensor 146, for example.

At a block 306, the first 3D model may be sent to another computing device. The computing device 104 may send the first 3D model to the computing device 102, for example. At a block 308, a second 3D model may be received at the computing device. The second 3D model may be received at the computing device 104 from the computing device 102 and may be a fuller representation of the 3D object. In embodiments, the object module 160 may be operated by the processor 140 to send the first 3D module to the other computing device at the block 306 and receive the second 3D module from the other computing device at the block 308.

At a block 310, the second 3D model may be displayed. In embodiments, the display module 162 may be operated by the processor 140 to display the second 3D model on the display 150. At a decision block 312, it may be determined whether a request to obtain information relating to component parts of the 3D object has been received. If, at the decision block 312, it is determined a request to obtain information relating to component parts has been received, a component parts request may be sent at a block 314. The object module 160 may be operated by the processor 140 to send the request to the computing device 102, for example. At a block 316, one or more 3D models of component parts may be received. In embodiments, the object module 160 may be operated by the processor 140 to receive the 3D models of the component parts and the display module 162 may be operated by the processor 140 to display the 3D models of the component parts on the display 150. The 3D models of the component parts may be displayed as an exploded view of the second 3D model or may be shown individually in various embodiments.

At a decision block 318, it may be determined whether a user would like to manipulate the second 3D model. In embodiments, the manipulation module 164 may be operated by the processor 140 to receive input from the input device 152 indicating a user wishes to manipulate the second 3D model. The process 300 may also proceed to the decision block 318 if, at the decision block 312, it is determined that a request to obtain information relating to component parts has not been received. If, at the decision block 318, it is determined that a user would like to manipulate the second 3D model, an altered 3D model may be generated at the block 320 based at least in part on information received from the input device 152. In embodiments, a request to modify the second 3D model may be sent to another computing device such as the computing device 102 and a 3D virtual skeleton model may be received in response to the request. In embodiments, the manipulation module 164 may be operated by the processor 140 to manipulate the second 3D model to generate the altered 3D model. In embodiments, the second 3D model may be manipulated or modified in variety of ways such as by adding or removing detail; changing colors; adding or removing labels, insignia, or other surface features; or adding, removing, or modifying a geometric aspect of the 3D model such that the altered 3D model includes at least one different geometry primitive than the second 3D model, for example. The second 3D model may also be manipulated by adding or changing metadata associated with the second 3D model, such as material type, material density, or names associated with the second 3D model. In embodiments, the 3D virtual skeleton model may be manipulated or modified rather than the second 3D model to generate the altered 3D model. At a block 322, the altered 3D model may be sent to the other computing device. In embodiments, the manipulation module 164 may be operated by the processor 140 to send the altered 3D model to the computing device 102.

At a decision block 324, it may be determined whether a user would like to print a 3D model using a 3D printer such as the 3D printer 178. The process 300 may also proceed to the decision block 324 if, at the decision block 318, it is not determined that a user would like to manipulate or modify the 3D model. In embodiments, the printing module 166 may be operated by the processor 140 to receive input from the input device 152 indicating a user wishes to print a 3D model such as the second 3D model, the altered 3D model, or one or more 3D models corresponding to the component parts associated with the second 3D model, for example. If, at the decision block 324, it is determined that a user would like to print a 3D model, a print command may be sent at a block 326. In embodiments, the printing module 166 may be operated by the processor 140 to send the print command based at least in part on the second 3D model, the altered 3D model, or one or more 3D models corresponding to the component parts.

In embodiments, the 3D printer may print a 3D object based at least in part on the print command sent at the block 326. A full-size or scaled model of the 3D object may be printed. The 3D object may be printed using material corresponding to materials specified in metadata associated with a 3D model. If, at the decision block 324, it is determined that a request to print a 3D model has not been received, the process 300 may return to the block 302, where another 2D image may be received. In embodiments, the process 300 may also return to the block 302 after sending the print command at the block 326.

FIG. 4 illustrates an example 2D object outline 400, in accordance with various embodiments. In embodiments, a 2D outline such as the 2D object outline 400 may be extracted from a 2D image taken of a 3D object before extracting a 3D model. The extraction module 158 may be operated by the processor 140 to extract the 2D object outline. As illustrated, the 2D object outline 400 is a partial outline and does not include the nose or wingtip of the represented aircraft. A first 3D model may be extracted by the extraction module 158 based at least in part on the partial outline. The first 3D model may be only a partial representation of the aircraft. The first 3D model may be sent to the computing device 102, and a second 3D model, fuller than the first 3D model, may be determined and sent back to the computing device 104 where it may be displayed and/or manipulated.

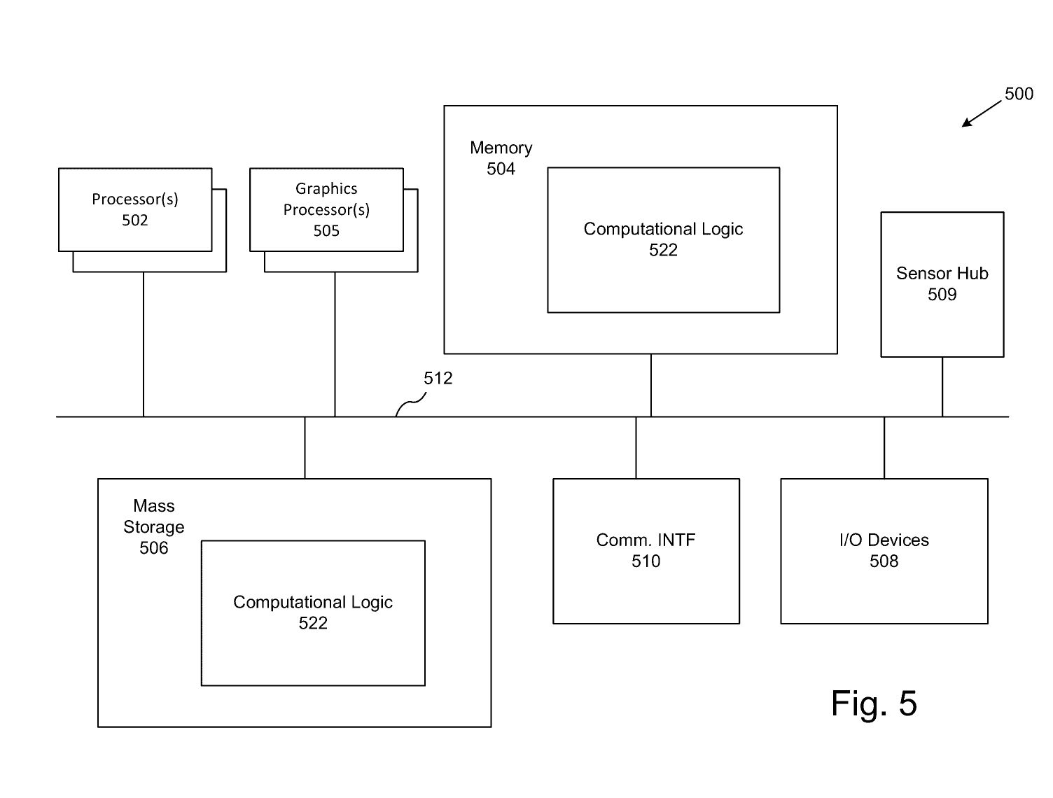

Referring now to FIG. 5, an example computer 500 suitable to practice the present disclosure as earlier described with reference to FIGS. 1-4 is illustrated in accordance with various embodiments. As shown, computer 500 may include one or more processors or processor cores 502, and system memory 504. For the purpose of this application, including the claims, the terms “processor” and “processor cores” may be considered synonymous, unless the context clearly requires otherwise. Additionally, computer 500 may include one or more graphics processors 505, mass storage devices 506 (such as diskette, hard drive, compact disc read only memory (CD-ROM) and so forth), input/output devices 508 (such as display, keyboard, cursor control, remote control, gaming controller, image capture device, and so forth), sensor hub 509, and communication interfaces 510 (such as network interface cards, modems, infrared receivers, radio receivers (e.g., Bluetooth), and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with the computing device 102 or the computing device 104, e.g., operations described for 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2, or process 300 of FIG. 3, collectively denoted as computational logic 522. The system memory 504 and mass storage devices 506 may also be employed to store a working copy and a permanent copy of the programming instructions implementing the operations associated with an OS running on the computing device 102 or the computing device 104. The system memory 504 and mass storage devices 506 may also be employed to store the data or local resources in various embodiments. The various elements may be implemented by assembler instructions supported by processor(s) 502 or high-level languages, such as, for example, C, that can be compiled into such instructions.

The permanent copy of the programming instructions may be placed into mass storage devices 506 in the factory, or in the field, through, for example, a distribution medium (not shown), such as a compact disc (CD), or through communication interface 510 (from a distribution server (not shown)). That is, one or more distribution media having an implementation of the agent program may be employed to distribute the agent and program various computing devices.

The number, capability and/or capacity of these elements 502-522 may vary, depending on whether computer 500 is a stationary computing device, such as a server, high performance computing node, set-top box or desktop computer, a mobile computing device such as a tablet computing device, laptop computer or smartphone, or an embedded computing device. Their constitutions are otherwise known, and accordingly will not be further described. In various embodiments, different elements or a subset of the elements shown in FIG. 5 may be used. For example, some devices may not include the graphics processor 505, may use a unified memory that serves as both memory and storage, or may couple sensors without using a sensor hub.

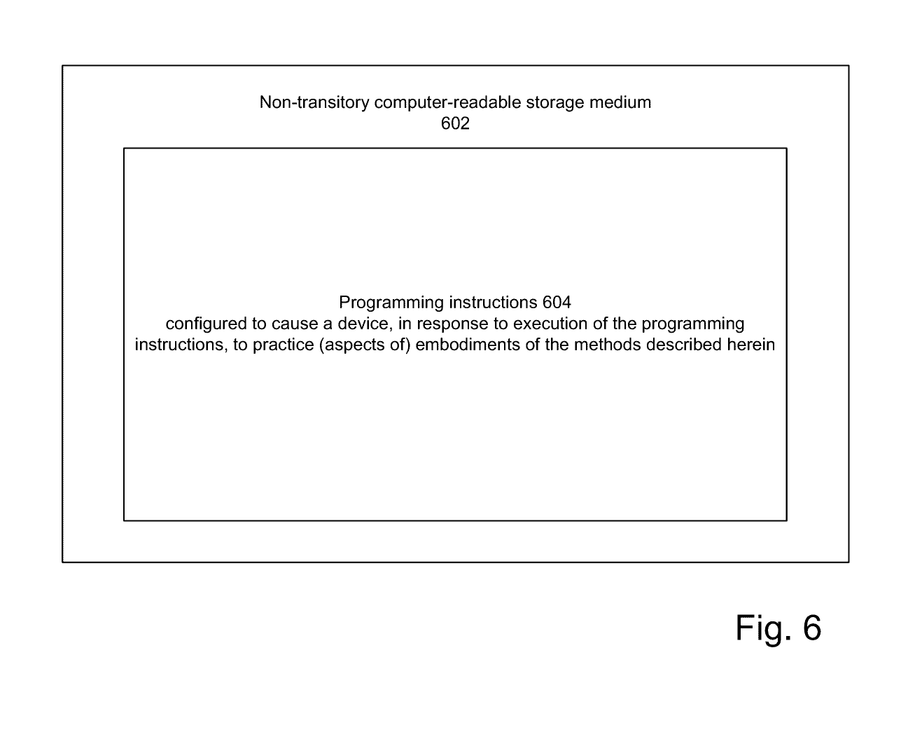

FIG. 6 illustrates an example at least one non-transitory computer-readable storage medium 602 having instructions configured to practice all or selected ones of the operations associated with the computing device 102 or the computing device 104, earlier described, in accordance with various embodiments. As illustrated, at least one non-transitory computer-readable storage medium 602 may include a number of programming instructions 604. The storage medium 602 may represent a broad range of persistent storage medium known in the art, including but not limited to flash memory, dynamic random access memory, static random access memory, an optical disk, a magnetic disk, etc. Programming instructions 604 may be configured to enable a device, e.g., computer 500, computing device 102, or computing device 104, in response to execution of the programming instructions 604, to perform, e.g., but not limited to, various operations described for 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2, or process 300 of FIG. 3. In alternate embodiments, programming instructions 604 may be disposed on multiple computer-readable storage media 602. In alternate embodiment, storage medium 602 may be transitory, e.g., signals encoded with programming instructions 604.

Referring back to FIG. 5, for an embodiment, at least one of processors 502 may be packaged together with memory having computational logic 522 configured to practice aspects described for 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2, or process 300 of FIG. 3. For an embodiment, at least one of processors 502 may be packaged together with memory having computational logic 522 configured to practice aspects described for 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2 or process 300 of FIG. 3 to form a System in Package (SiP). For an embodiment, at least one of processors 502 may be integrated on the same die with memory having computational logic 522 configured to practice aspects described for 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2 or process 300 of FIG. 3. For an embodiment, at least one of processors 502 may be packaged together with memory having computational logic 522 configured to practice aspects of 3D modeling module 114, componentization module 116, database update module 118, database 120, extraction module 158, object module 160, display module 162, manipulation module 164, printing module 166 and other modules 126 and 168, shown in FIG. 1, or operations shown in process 200 of FIG. 2 or process 300 of FIG. 3 to form a System on Chip (SoC). For at least one embodiment, the SoC may be utilized in, e.g., but not limited to, a mobile computing device such as a wearable device and/or a smartphone.

Machine-readable media (including non-transitory machine-readable media, such as machine-readable storage media), methods, systems and devices for performing the above-described techniques are illustrative examples of embodiments disclosed herein. Additionally, other devices in the above-described interactions may be configured to perform various disclosed techniques.

### EXAMPLES

Example 1 may include a computing device comprising: one or more processors; and a three dimensional (3D) modeling module operated by the one or more processors to: receive a first 3D model of a 3D object; and determine a second 3D model to replace the first 3D model, wherein the second 3D model is a fuller representation of the 3D object than the first 3D model.

Example 2 may include the subject matter of Example 1, wherein the 3D modeling module is to determine the second 3D model based at least in part on rotating and scaling at least one of the first 3D model or the second 3D model.

Example 3 may include the subject matter of any one of Examples 1-2, wherein the 3D modeling module is to determine the second 3D model based at least in part on a machine learning algorithm.

Example 4 may include the subject matter of any one of Examples 1-3, further comprising a componentization module operated by the one or more processors to: determine 3D models of component parts associated with the second 3D model.

Example 5 may include the subject matter of any one of Examples 1-4, wherein the second 3D model includes metadata corresponding to a material property of the 3D object.

Example 6 may include the subject matter of any one of Examples 1-5, further comprising a database update module operated by the one or more processors to: receive an altered 3D model based at least in part on the second 3D model; and update a database based at least in part on the altered 3D model.

Example 7 may include the subject matter of Example 6, wherein the altered 3D model includes at least one different geometry primitive than the second 3D model.

Example 8 may include a computing device comprising: one or more processors; a camera; a display; an extraction module operated by the one or more processors to: receive a two dimensional (2D) image of a 3D object taken by the camera; and extract a first three dimensional (3D) model based at least in part on the 2D image; an object module operated by the one or more processors to: send the first 3D model to another computing device; and receive a second 3D model from the other computing device; and a display module operated by the one or more processors to display the second 3D model on the display, wherein the second 3D model is a fuller representation of the 3D object than the first 3D model.

Example 9 may include the subject matter of Example 8, wherein the object module is also operated by the one or more processors to receive 3D models of component parts associated with the second 3D model, and wherein the display module is also operated by the one or more processors to display the 3D models of component parts.

Example 10 may include the subject matter of any one of Examples 8-9, further comprising a manipulation module operated by the one or more processors to manipulate the second 3D model to generate an altered 3D model.

Example 11 may include the subject matter of any one of Examples 8-10, further comprising a printing module operated by the one or more processors to send a command to a 3D printer based at least in part on the second 3D model.

Example 12 may include a computer implemented method comprising: receiving a first 3D model of a three dimensional (3D) object at a computing device; and determining, by the computing device, a second 3D model to replace the first 3D model, wherein the second 3D model is a fuller representation of the 3D object than the first 3D model.

Example 13 may include the subject matter of Example 12, wherein determining the second 3D model includes rotating and scaling at least one of the first 3D model or the second 3D model.

Example 14 may include the subject matter of any one of Examples 12-13, wherein determining the second 3D model is based at least in part on a machine learning algorithm.

Example 15 may include the subject matter of any one of Examples 12-14, further comprising determining, by the computing device, material characteristics associated with the second 3D model.

Example 16 may include the subject matter of any one of Examples 12-15, further comprising determining, by the computing device, 3D models of component parts associated with the second 3D model.

Example 17 may include the subject matter of any one of Examples 12-16, further comprising: receiving, by the computing device, an altered 3D model based at least in part on the second 3D model; and updating, by the computing device, a database based at least in part on the altered 3D model.

Example 18 may include the subject matter of Example 17, wherein the altered 3D model includes at least one different geometry primitive than the second 3D model.

Example 19 may include at least one non-transitory computer-readable medium comprising instructions stored thereon that, in response to execution of the instructions by one or more processors of a computing device, cause the computing device to: receive a first 3D model of a three dimensional (3D) object; and determine a second 3D model to replace the first 3D model, wherein the second 3D model is a fuller representation of the 3D object than the first 3D model.

Example 20 may include the subject matter of Example 19, wherein the computing device is caused to determine the second 3D model based at least in part on rotating and scaling at least one of the first 3D model or the second 3D model.

Example 21 may include the subject matter of any one of Examples 19-20, wherein the computing device is caused to determine the second 3D model based at least in part on a machine learning algorithm.

Example 22 may include the subject matter of any one of Examples 19-21, wherein the computing device is also caused to determine material characteristics associated with the second 3D model.

Example 23 may include the subject matter of any one of Examples 19-22, wherein the computing device is also caused to: determine 3D models of component parts associated with the second 3D model.

Example 24 may include the subject matter of any one of Examples 19-23, wherein the computing device is further caused to: receive an altered 3D model based at least in part on the second 3D model; and update a database based at least in part on the altered 3D model.

Example 25 may include the subject matter of Example 24, wherein the altered 3D model includes at least one different geometry primitive than the second 3D model.

Example 26 may include an apparatus for computing comprising: means for receiving a first 3D model of a three dimensional (3D) object; and means for determining a second 3D model to replace the first 3D model, wherein the second 3D model is a fuller representation of the 3D object than the first 3D model.

Example 27 may include the subject matter of Example 26, wherein the means for determining the second 3D model includes means for rotating and scaling at least one of the first 3D model or the second 3D model.

Example 28 may include the subject matter of any one of Examples 26-27, wherein the means for determining the second 3D model is to determine the second 3D model based at least in part on a machine learning algorithm.

Example 29 may include the subject matter of any one of Examples 26-28, further comprising means for determining material characteristics associated with the second 3D model.

Example 30 may include the subject matter of any one of Examples 26-29, further comprising means for determining 3D models of component parts associated with the second 3D model.

Example 31 may include the subject matter of any one of Examples 26-30, further comprising: means for receiving an altered 3D model based at least in part on the second 3D model; and means for updating a database based at least in part on the altered 3D model.

Example 32 may include the subject matter of Example 31, wherein the altered 3D model includes at least one different geometry primitive than the second 3D model.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computing device comprising:
one or more processors; and
a three dimensional (3D) modeling module operated by the one or more processors to:
receive a first 3D model of a 3D object; and
determine a second 3D model to replace the first 3D model, wherein the second 3D model is a fuller representation of the 3D object than the first 3D model.

2. The computing device of claim 1, wherein the 3D modeling module is to determine the second 3D model based at least in part on rotating and scaling at least one of the first 3D model or the second 3D model.

3. The computing device of claim 1, wherein the 3D modeling module is to determine the second 3D model based at least in part on a machine learning algorithm.

4. The computing device of claim 1, further comprising a componentization module operated by the one or more processors to:
determine 3D models of component parts associated with the second 3D model.

5. The computing device of claim 1, wherein the second 3D model includes metadata corresponding to a material property of the 3D object.

6. The computing device of claim 1, further comprising a database update module operated by the one or more processors to:
receive an altered 3D model based at least in part on the second 3D model; and
update a database based at least in part on the altered 3D model.

7. The computing device of claim 6, wherein the altered 3D model includes at least one different geometry primitive than the second 3D model.

8. A computing device comprising:
one or more processors;
a camera;
a display;
an extraction module operated by the one or more processors to:
receive a two dimensional (2D) image of a 3D object taken by the camera; and
extract a first three dimensional (3D) model based at least in part on the 2D image;
an object module operated by the one or more processors to:
send the first 3D model to another computing device; and
receive a second 3D model from the other computing device; and
a display module operated by the one or more processors to display the second 3D model on the display, wherein the second 3D model is a fuller representation of the 3D object than the first 3D model.

9. The computing device of claim 8, wherein the object module is also operated by the one or more processors to receive 3D models of component parts associated with the second 3D model, and wherein the display module is also operated by the one or more processors to display the 3D models of component parts.

10. The computing device of claim 8, further comprising a manipulation module operated by the one or more processors to manipulate the second 3D model to generate an altered 3D model.

11. The computing device of claim 8, further comprising a printing module operated by the one or more processors to send a command to a 3D printer based at least in part on the second 3D model.

12. A computer implemented method comprising:
receiving a first 3D model of a three dimensional (3D) object at a computing device; and
determining, by the computing device, a second 3D model to replace the first 3D model, wherein the second 3D model is a fuller representation of the 3D object than the first 3D model.

13. The computer implemented method of claim 12, wherein determining the second 3D model includes rotating and scaling at least one of the first 3D model or the second 3D model.

14. The computer implemented method of claim 12, wherein determining the second 3D model is based at least in part on a machine learning algorithm.

15. The computer implemented method of claim 12, further comprising determining, by the computing device, material characteristics associated with the second 3D model.

16. The computer implemented method of claim 12, further comprising determining, by the computing device, 3D models of component parts associated with the second 3D model.

17. The computer implemented method of claim 12, further comprising:
receiving, by the computing device, an altered 3D model based at least in part on the second 3D model; and
updating, by the computing device, a database based at least in part on the altered 3D model.

18. The computer implemented method of claim 17, wherein the altered 3D model includes at least one different geometry primitive than the second 3D model.

19. At least one non-transitory computer-readable medium comprising instructions stored thereon that, in response to execution of the instructions by one or more processors of a computing device, cause the computing device to:
receive a first 3D model of a three dimensional (3D) object; and
determine a second 3D model to replace the first 3D model, wherein the second 3D model is a fuller representation of the 3D object than the first 3D model.

20. The at least one non-transitory computer-readable medium of claim 19, wherein the computing device is caused to determine the second 3D model based at least in part on rotating and scaling at least one of the first 3D model or the second 3D model.

21. The at least one non-transitory computer-readable medium of claim 19, wherein the computing device is caused to determine the second 3D model based at least in part on a machine learning algorithm.

22. The at least one non-transitory computer-readable medium of claim 19, wherein the computing device is also caused to determine material characteristics associated with the second 3D model.

23. The at least one non-transitory computer-readable medium of claim 19, wherein the computing device is also caused to:
determine 3D models of component parts associated with the second 3D model.

24. The at least one non-transitory computer-readable medium of claim 19, wherein the computing device is further caused to:
receive an altered 3D model based at least in part on the second 3D model; and
update a database based at least in part on the altered 3D model.

25. The at least one non-transitory computer-readable medium of claim 24, wherein the altered 3D model includes at least one different geometry primitive than the second 3D model.
